(19) United States
(12) Patent Application Publication
(10) Pub. No.: US 2005/0006505 A1
(43) Pub. Date: Jan. 13, 2005

(54) Folding food grater

(76) Inventors: Carolyn McNeeley, Brunswick, OH (US); W. Scott Hughes, Chicago, IL (US); Christine Beilstein, Chicago, IL (US); Dennis Jenkins, Canton, OH (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/796,379

(22) Filed: Mar. 9, 2004

Related U.S. Application Data
(60) Provisional application No. 60/454,283, filed on Mar. 11, 2003.
(60) Provisional application No. 60/493,557, filed on Aug. 8, 2003.

(51) Int. Cl. A47J 43/25

(52) U.S. Cl. 241/95

(57) ABSTRACT

Three panel pyramid-type food graters are disclosed which include a center panel hingedly connected to right and left panels and whereby the right and left panels snap together to form the partial pyramid shape. The right and left panels may be snapped apart and the grater folded into a flat compact position for easy storage and merchandising. Further, both sides of each grating panel may easily be cleaned when the right and left panels are snapped apart. A cap is also provided which may provide extra stability to the structure when in use.

### CROSS-REFERENCE TO RELATED APPLICATION

This application claims the benefit under 35 U.S.C. § 119(e) of U.S. Provisional Patent Application No. 60/454,283, filed Mar. 11, 2003 and U.S. Provisional Patent Application Ser. No. 60/493,557, filed Aug. 8, 2003, the disclosures of which are incorporated herein by reference.

### BACKGROUND

1. Technical Field

An improved food grater is disclosed that comprises three hinged panels that form a partial triangular pyramid shape when opened and locked together. The grater can be folded down into a flat configuration for convenient storage and merchandising.

2. Description of the Related Art

Standing food graters, such as cheese or vegetable graters are inherently large and therefore difficult to store during home use and are also difficult to merchandise in a store due to the large volume or large amounts of shelf space consumed by such graters. Rigid pyramid shaped graters, while preferred by consumers because of their stable footprint, ease of use, and three different grating panels, are difficult to clean near the narrow top portion of the grater. An example of a rigid pyramid-shaped standing food grater is found in U.S. Pat. Nos. 6,135,375 and D438,433. Not only are these graters large and therefore difficult to store in a kitchen drawer due to their bulky shape, they are also difficult to clean, particularly near the narrow top.

Examples of more compact graters are found in U.S. Pat. Nos. 5,312,054 and 4,805,843. The '054 patent discloses a foldable grater that provides for only two grating surfaces. Despite the fact that it only provides two grating surfaces, it is still relatively large and bulky. Further, the grater disclosed in the '054 patent does not provide the stable footprint provided by the pyramid-shaped grater disclosed in the '375 patent.

A more compact grater design is disclosed in U.S. Pat. No. 4,805,843. This grater attempts to solve the unstable footprint problem by providing a mechanism for connecting the grater to a mixing bowl. However, this design provides only one grating surface and has limited versatility.

Therefore, there is a need for an improved grater that may assume the stable pyramid position preferred by consumers and that provides more than one or two grating surfaces but that is also easy to clean, relatively compact, and which consumes less space thereby making the grater more easy to merchandise and stock in a retail environment.

### BRIEF DESCRIPTION OF THE DRAWINGS

The disclosed grater is described more or less diagrammatically in the accompanying drawings, wherein:

FIG. 1 is a perspective view of a disclosed three panel grater in an assembled, ready-to-use position;

FIG. 2 is a top plan view of the grater shown in FIG. 1;

FIG. 3 is a front plan view of the grater shown in FIG. 1;

FIG. 4 is a top perspective view of the cap for the grater shown in FIG. 1;

FIG. 5 is a bottom perspective view of the cap shown in FIG. 4;

FIGS. 6A-6C are perspective front plan and top views of the grater shown in FIGS. 1-5 as the grater is moved from an upright position and ready for use as shown in FIG. 1 to a folded position as shown in FIGS. 6A-6C;

FIG. 7 is a rear plan view of the folded grater shown in FIG. 6;

FIG. 8 is a side plan view of the folded grater shown in FIGS. 6 and 7;

FIG. 9 is a front plan view of a first grating panel of the grater shown in FIGS. 1-8;

FIG. 10 is a partial sectional view taken substantially along line 10-10 of FIG. 9;

FIG. 11 is a right side view of the grating panel shown in FIG. 9;

FIG. 12 is a rear plan view of the grating panel shown in FIG. 9;

FIG. 13 is an exploded view of the grating panel shown in FIGS. 9-12 separately illustrating the frame, grip inserts and grating insert;

FIG. 14 is a front plan view of a second grating panel of the grater shown in FIGS. 1-8;

FIG. 15 is a partial sectional view taken substantially along line 15-15 of FIG. 14;

FIG. 16 is a right side view of the grating panel shown in FIG. 14;

FIG. 17 is a rear plan view of the grating panel shown in FIG. 14;

FIG. 18 is an exploded view of the grating panel shown in FIGS. 14-17 separately illustrating the frame, grating insert and grip inserts;

FIG. 19 is a front plan view of a third grating panel of the grater shown in FIGS. 1-8;

FIG. 20 is a partial sectional view taken substantially along line 20-20 of FIG. 19;

FIG. 21 is a right side view of the grating panel shown in FIG. 19;

FIG. 22 is a rear plan view of the grating panel shown in FIG. 19;

FIG. 23 is an exploded view of the grating panel shown in FIGS. 19-22, separately illustrating the frame, grating insert and grip inserts;

FIG. 24 is a perspective view of an alternative food grater in an upright position and ready for use;

FIGS. 25-27 schematically illustrate a method for collapsing the food grater shown in FIG. 24 to either a folded position (FIG. 26) or a flat position (FIG. 27) for storage purposes;

FIG. 28 is a perspective view of yet another alternative food grater having a triangular pyramid shape in an upright position and ready for use; and

FIG. 29 is a perspective view illustrating how the food grater shown in FIG. 28 is collapsed and folded for storage purposes.

The drawings are not to scale and some details or features may have been omitted for the sake of simplicity. This disclosure is not limited to the three embodiments shown in the drawings.

### DETAILED DESCRIPTION OF THE PRESENTLY PREFERRED EMBODIMENTS

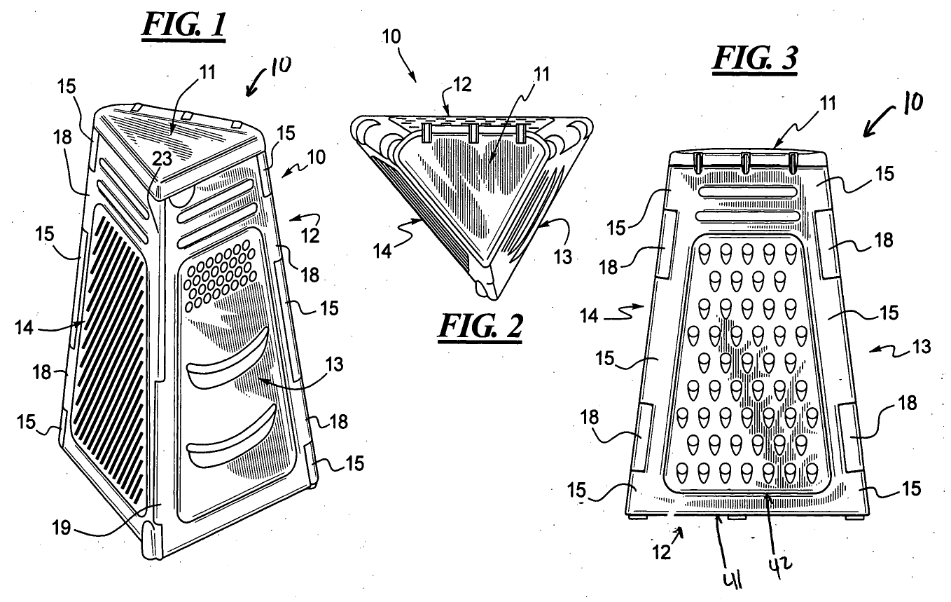

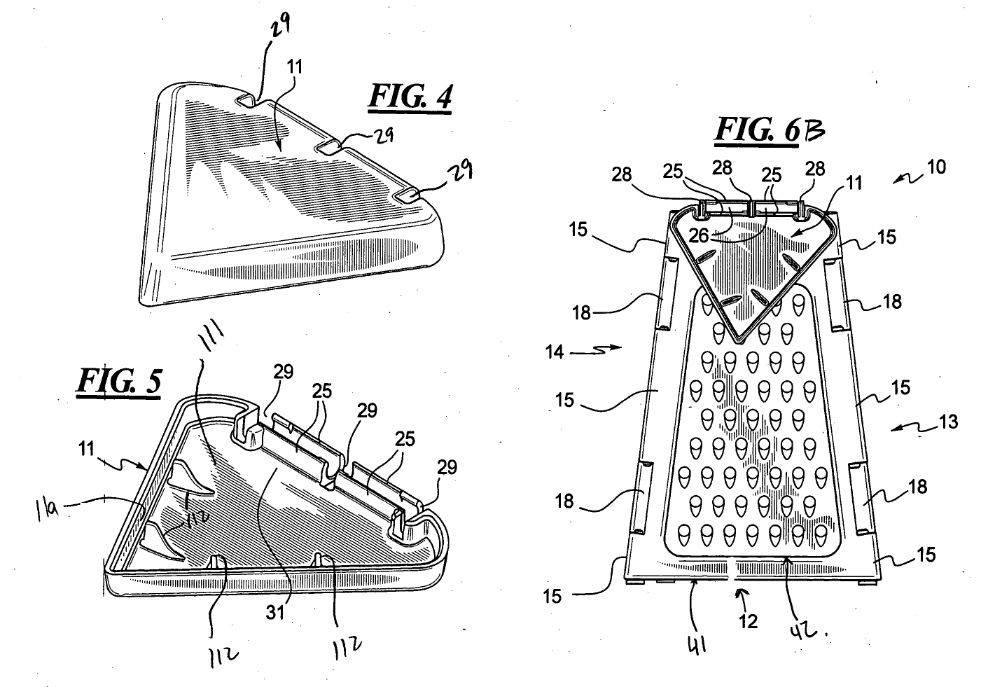

FIG. 1 is a perspective view of an assembled grater 10 made in accordance with this disclosure. The grater 10 includes a cap 11 as shown in FIGS. 2 and 4-5 which stabilizes the three grating panels, 12, 13 and 14. As shown in FIG. 1, the cap 11 mateably receives the upper ends of the panels 12-14. The panels 13, 14 are hingedly connected to the center panel 12 by way of the upper, lower and middle hinge mechanisms 15 of the panel 12 and the complementary hinge mechanisms 18 of the panels 13 and 14 as shown in FIGS. 1 and 3.

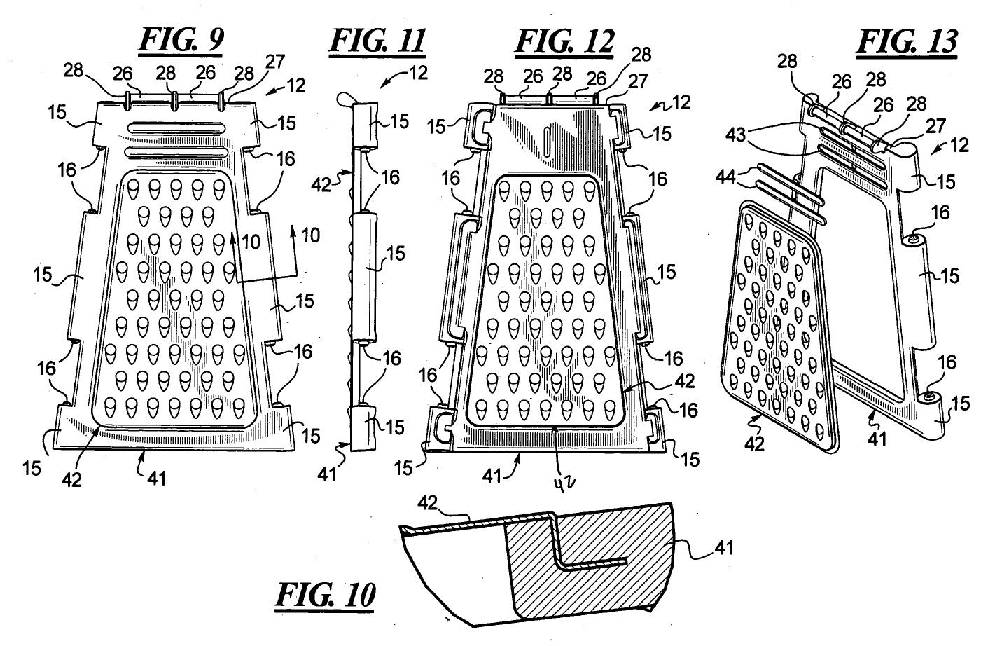

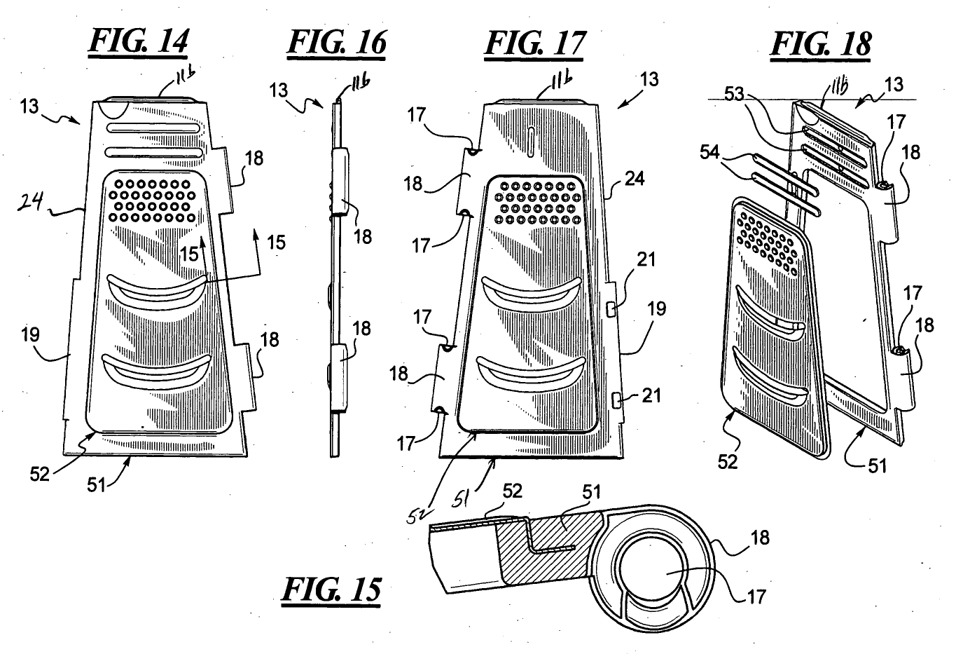

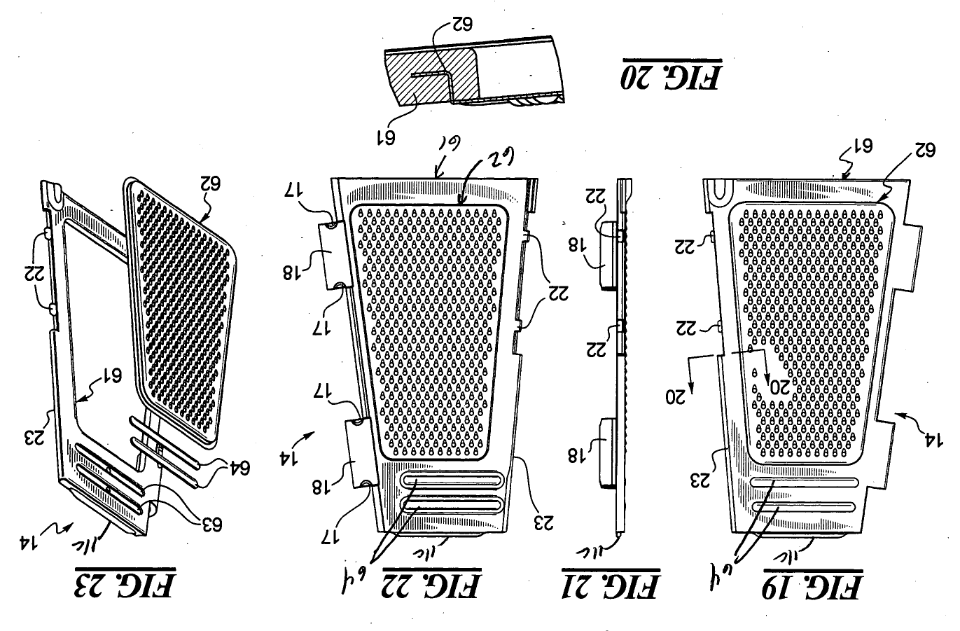

Referring to FIG. 9, each hinge mechanism 15 includes one or two protruding members shown at 16 that are received in complimentary recesses 17 of the hinge members 18 of the panels 13 and 12 as shown in FIGS. 17 and 22. In contrast, the right and left grating panels 13, 14 are not hingedly connected together but, instead, can be easily snapped together by way of the complimentary closure mechanisms 19, 21, 24 (FIGS. 14 and 17) and 22, 23 (FIGS. 19 and 23) attached to the panels 13, 14, respectively.

Specifically, the panel 13 includes a lip shown at 19 in FIG. 17 whereby the lip 19 includes two openings or recesses shown at 21. The lip 19 snaps over the nipples 22 of the panel 14 (see FIGS. 19 and 22) and the nipples 22 are received in the corresponding slots or recesses 21 of the lip 19 of the panel 13 (see FIG. 17). Further, the panel 14 includes a lip 23 (see FIG. 19) that snaps over the corresponding ridge 24 of the panel 13 (see FIG. 17).

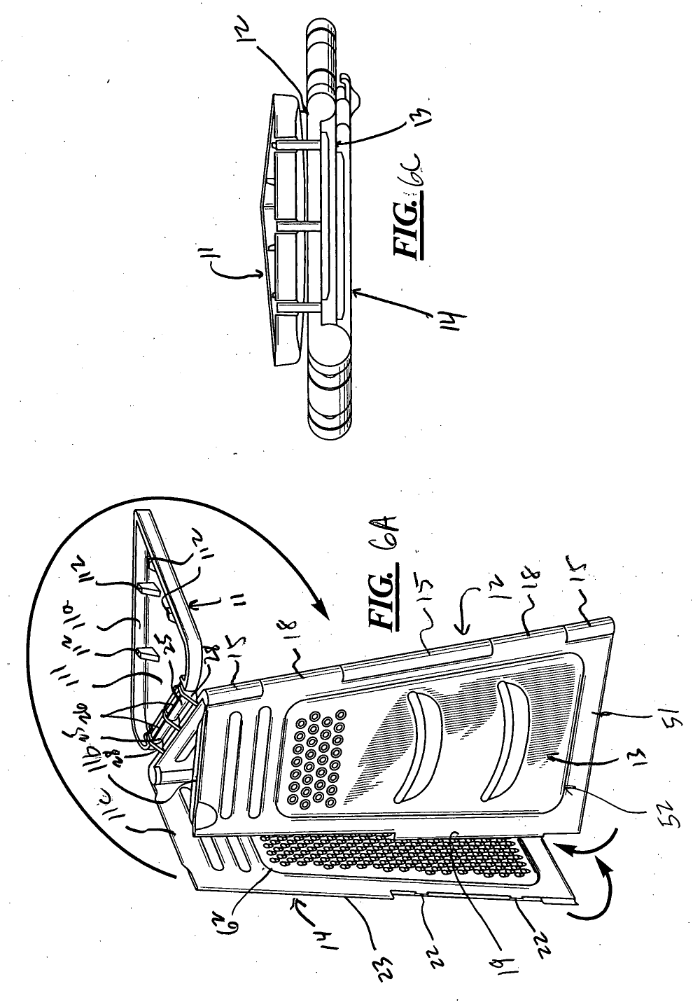

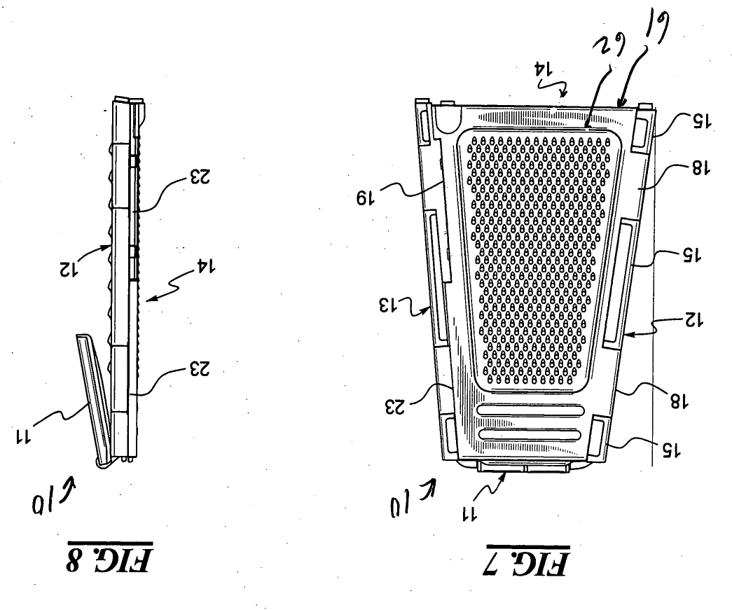

Turning to FIGS. 5 and 9-13, the cap 11 snaps onto the panel 12 by way of the two pairs of spaced-apart prongs 25 which receive the corresponding ribs 26 disposed at an upper edge 27 of the panel 12. See FIGS. 5, 10 and 12-13. Further, the ribs 26 extend between three transverse flanges shown at 28 in FIGS. 9 and 12-13. These transverse flanges 28 are received in the slots 29 disposed along the rear edge 31 of the cap 11 as shown in FIG. 5. Thus, the cap 11 is pivotally connected to the top edge 27 of the panel 12 and, when the grater 10 is folded as shown in FIGS. 6-8, the cap 11 may be folded backwards and over the panel 12 as shown in FIGS. 6 and 8.

In FIG. 1, the grater 10 is in an assembled and ready to use position. As shown in FIG. 6A, the cap 11 includes a downwardly extending rim 11a that mateably receives the upper edges 11b, 11c of the panels 13, 14 respectively. The underside 111 of the cap 11 also includes protruding members shown at 112 that, together with the rim 11a, sandwich the panels 13, 14 to further stabilize the grater 10 as it is shown in FIG. 1.

To fold the grater 10 for storage or displaying in a store or retail outlet, the cap 11 is folded upward and backward from the position shown in FIG. 1 towards the position shown in FIG. 6A. Then, also as shown in FIG. 6A, the panels 13, 14 are disconnected and folded inward towards the panel as shown in FIGS. 6B and 6C to assume a compact position as shown in FIGS. 6B and 6C so that the grater 10 can be hung using a hang top on a store wire rack or in a kitchen drawer.

The grater 10 may also assume a flat position as shown with respect to the grater 70 as shown in FIG. 27. Also, the grater 10 and the other disclosed graters 70, 100 may also include four or more panels as opposed to the three panel designs shown.

Returning to FIGS. 9-13, the panel 12 is illustrated in greater detail. The panel 12 includes an outer frame 41, that may be fabricated from plastic, and that receives a metal grating insert 42. The grating insert 42 may be molded into the frame 41 as shown by the detail of FIG. 10. Further, as shown in FIG. 13, the frame 41 may include a plurality of transverse slots 43 for receiving gripping or pad elements shown at 44.

Turning to FIGS. 14-18, the panel 13 is illustrated in greater detail. Again, the panel 13 may include an outer frame 51 that receives a metal grating or slicing insert 52. As shown in FIG. 15, the insert 52 may be molded into the frame 51. Similarly, as shown in FIG. 18, the frame 51 may include transverse slots 53 for receiving gripping or pad inserts shown at 54.

Turning to FIGS. 19-23, the grating panel 14 is illustrated in greater detail and, also includes a frame 61 which receives a metal grating insert 62 that may be molded into the frame 61 as shown in FIG. 20. Also, as shown in FIG. 23, the frame 61 may include one or more transverse slots 63 for receiving gripping or pad inserts 64.

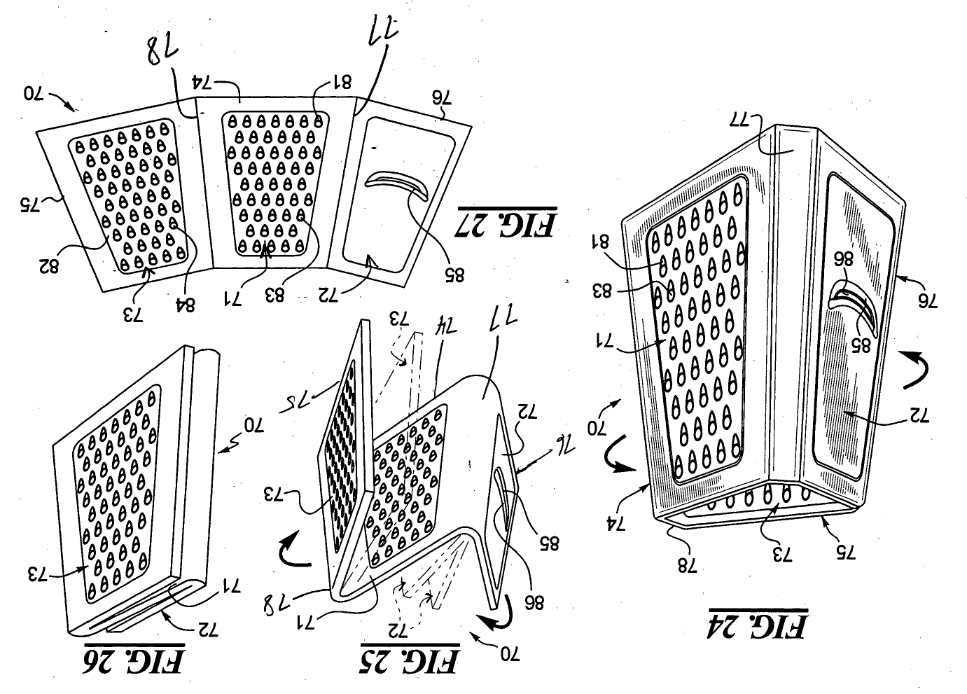

FIGS. 24-27 illustrate another example of a food grater 70 made in accordance with this disclosure. The grater 70 assumes a triangular pyramid shape similar to the grater illustrated in FIGS. 1-23. Three different grating panels 71-73 are provided. Preferably, the grating panels 71-73 are made from a sturdy metallic material, such as stainless steel. The panels 71-73 are molded into outer frames 74-76, respectively. As shown in FIG. 24, the outer frames 76, 74 have a living hinge 77 disposed therebetween and, similarly, the outer frames 74, 75 also have a living hinge 78 disposed therebetween. The frames 75, 76 are not connected and preferably include a snap connection to provide a sturdy footprint when in the assembled position as shown in FIG. 24. In the embodiments shown in FIGS. 24-27, the panel 71, 73 have grating blades 81, 82 and corresponding food passage holes 83, 84 of different sizes to provide different textures of grated foods. The panel 72 includes a slicing mechanism 85 and corresponding slot shown at 86.

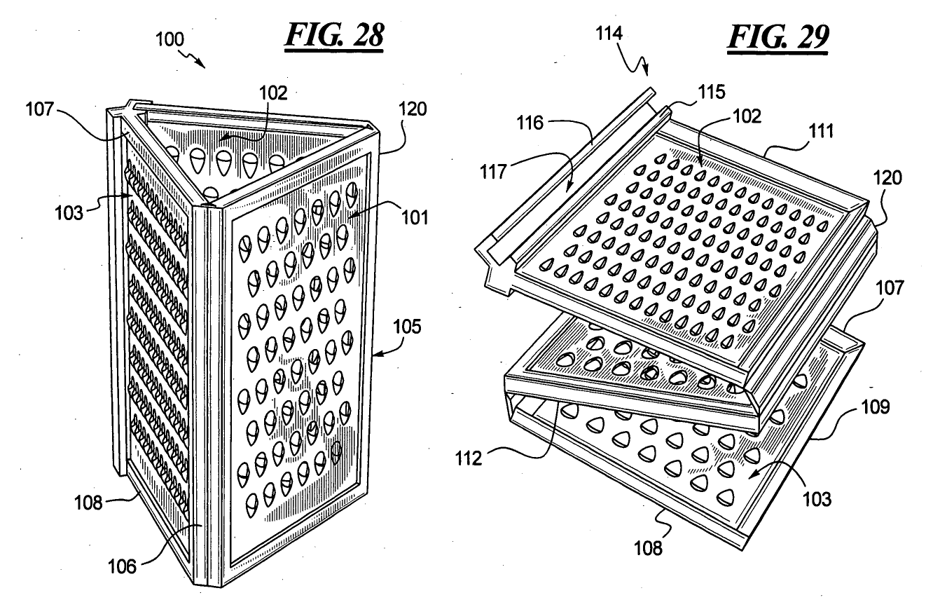

An alternative grater 100 is shown in FIGS. 28 and 29. Again, three grating panels are provided as shown at 101, 102, 103. The panel 101 is molded within an outer frame shown at 105. This frame 105 forms a living hinge 106 disposed between the grating plates 101, 103. The grating plate 106 includes a partial frame having upper and lower frame members 107, 108. The panel 103 then terminates at a leading edge 109. Referring to the panel 102, it too also includes upper and lower frame members 111, 112. The grating panel 102 then terminates at a slotted bracket shown generally at 114. The bracket 114 includes inner and outer walls 115, 116 with a slot 117 disposed therebetween. The slot 117 receives the leading edge 109 of the grating panel 103 as shown in FIG. 28. The upper and lower frame members 111, 112 then form the living hinge 120 that forms part of the frame 105 that surrounds the plate member 101 as best seen in FIG. 28.

The frame members 41, 51, 61, 74, 75, 76, 105, 107, 108, 111 and 112 can be fabricated from readily available plastic material such as high density polyethylene, polypropylene or polystyrene. Polystyrene is one preferred material as it helps the graters 10, 70 and 100 from slipping during use. The grating panels, shown at 12-14, 71-73 and 102-103 are preferably fabricated from stainless steel for easy cleanability and rust prevention. The stabilizing cap 11 may be fabricated from the same plastic material used to fabricate the frames 41, 51 and 61.

The disclosed graters are designed to fit in and be used in conjunction with multiple sized mixing bowls. Thus, the disclosed graters can be used in a serving for a mixing bowl and the grated food will directly into the bowl. This eliminates the need to transfer grated food from the location where it has been grated to the serving or mixing bowl.

The disclosed designs also give the consumer the benefit of a triangular pyramid-shaped grater that is stable and easy to use.

Specifically, by providing graters with multiple flat grating plates, the consumer may easily clean the disclosed graters. In the flat position (see FIG. 27), the disclosed graters can be easily scrubbed on both sides of the grating plates, unlike the rigid pyramid or box-shaped graters known in the art.

Still further, the disclosed graters may also be safely stored because they can be folded so that the sharp edges of the grating plates are facing inside or towards one another. Thus, there is less risk of a consumer cutting herself or himself while reaching into the drawer to retrieve the disclosed graters.

Thus, three collapsible pyramid-type three panel food graters are shown and described. The disclosed embodiments are completely collapsible and because the middle panels are hingedly connected to the right and left panels, the graters may be opened easily for cleaning on both sides of each panel.

Although only a certain embodiment has been described herein, the scope and coverage of this application and forthcoming patent is not limited thereto. In the contrary, this application and forthcoming patent is intended to cover all embodiments of the teachings of this disclosure that fairly fall within the scope of the allowed claims.

1. A food grater comprising:
at least three grating panels including a first end panel, a middle panel and a third end panel, the middle panel disposed between and hingedly connected to the first and third end panels, the first and third end panels comprising a latch mechanism for detachably connecting the first end panel to the third end panel.

2. The food grater of claim 1 wherein the first, middle and third panels each have truncated triangular shapes so that when the first panel is connected to the third panel, the grater has a truncated triangular pyramid configuration.

3. The grater of claim 1 further comprising a triangular cap,
the first, middle and third panels each having a top edge,
the cap being capable of mateably receiving the top edges of the first, middle and third panels when the first panel is connected to the middle panel.

4. The grater of claim 3 wherein the cap is hingedly connected to one of the grating panels.

5. The grater of claim 1 wherein the middle panel is connected to the first and third panels by living hinges.

6. The grater of claim 5 wherein each grating panel comprises a metallic grating panel surrounded by a plastic fame, the frames of the middle and first panels forming the living hinge connecting the middle panel to the first panel and the frames of the middle and third panels forming the living hinge connecting the middle panel to the third panel.

7. The grater of claim 1 wherein each grating panel comprises a plastic outer frame molded around a metallic plate.

8. The grater of claim 6 wherein the frames also comprise foot rests on lower edges thereof.

9. The grater of claim 6 wherein the frames comprise injection molded styrene.

10. The grater of claim 1 wherein each grating panel comprises one or more grating elements and wherein each panel performs a different grating function than the other panels.

11. The grater of claim 1 wherein the panels are uniformly rectangular in shape.

12. The grater of claim 1 wherein each panel comprises one or more outwardly protruding grating elements and the first and third panels can be folded over the middle panel so that the one or more outwardly protruding grating elements of the middle panel are covered by either the first or third panels and the one or more outwardly protruding grating elements of the first and the third panels are facing towards the middle panel when the grater is in a folded and collapsed position.

13. The grater of claim 1 further comprising two middle panels disposed between and hingedly connected to the first and third end panels.

14. A food grater comprising:
three grating panels including a first panel, a second panel and a third panel, the second panel disposed between and hingedly connected to the first and third panels, the first and third panels comprising a latch mechanism for detachably connecting the first panel to the third panel,
each panel further comprises one or more outwardly protruding grating elements,
the first and third panels being foldable over the second panel so that the one or more outwardly protruding grating elements of the second panel are covered by either the first or third panels and the one or more outwardly protruding grating elements of the first and the third panels are facing towards the second panel when the first and third panels are folded over the second panel.

15. The food grater of claim 14 wherein the first, second and third panels each have truncated triangular shapes so that when the first panel is connected to the third panel, the grater has a truncated triangular pyramid configuration.

16. The grater of claim 14 further comprising a triangular cap and the first, second and third panels each have a top edge, the cap mateably receiving the top edges of the first, second and third panels when the first panel is connected to the second panel.

17. The grater of claim 14 wherein the cap is hingedly connected to one of the grating panels.

18. The grater of claim 14 wherein the second panel is connected to the first and third panels by living hinges,
wherein each grating panel comprises a metallic grating panel surrounded by a plastic fame, the frames of the second and first hinge forming the living hinge connecting the second panel to the first panel and the frames of the second and third panels forming the living hinge connecting the second panel to the third panel.

19. A food grater comprising:
three grating panels including a first panel, a second panel and a third panel, the second panel disposed between and hingedly connected to the first and third panels, the first and third panels comprising a latch mechanism for detachably connecting the first panel to the third panel, wherein each panel comprises one or more outwardly protruding grating elements and the first and third panels can be folded over the second panel so that the one or more outwardly protruding grating elements of the second panel are covered by either the first or third panels and the one or more outwardly protruding grating elements of the first and the third panels are facing towards the second panel,
the first, second and third panels each have truncated triangular shapes so that when the first panel is connected to the third panel, the grater has a truncated triangular pyramid configuration,
the grater further comprising a triangular cap,
the first, second and third panels each have a top edge, the cap being capable of mateably receiving the top edges of the first, second and third panels when the first panel is connected to the second panel,
the cap is hingedly connected to one of the grating panels.

20. The grater of claim 19 wherein each grating panel comprises a plastic outer frame molded around a metallic plate.
